(19) United States
(12) Patent Application Publication
(10) Pub. No.: US 2005/0229378 A1
(43) Pub. Date: Oct. 20, 2005

(54) Method and device for permanently joining overlapping, plate-shaped parts

(75) Inventors: Stephan Dietrich, Dresden (DE); Reinhard Mauermann, Dresden (DE)

Correspondence Address: COCHRAN FREUND & YOUNG LLC, 2026 CARIBOU DR, SUITE 200, FORT COLLINS, CO, 80525, US

(73) Assignee: Fraunhofer-Gesellschaft zur Foerderung der angewandten Forschung e.V., Munich (DE)

(21) Appl. No.: 11/095,930

(22) Filed: Mar. 30, 2005

(30) Foreign Application Priority Data
Sep. 30, 2003 (WO) PCT/EP03/10843
Sep. 30, 2002 (DE) 102 45 604.6

(51) Int. Cl. B23P 11/00; B21D 39/00

(52) U.S. Cl. 29/514; 29/505; 29/715

(57) ABSTRACT

Especially for increasing the process security and reliability of permanent connections between overlapping materials, a method is suggested for permanently joining overlapping plate-shaped parts, particularly metal sheets, by producing an undercut between the parts in a deforming manner, the method comprising the following steps: disposing the parts to be joined between a protrusion of a punch tool and a support area of a counter-tool, forming a temporary elevation on the side of the parts that faces the counter-tool, by pressing the punch protrusion into the parts to be joined against the support area at least until the parts rise from the support area outside the forming elevation, and forming an undercut in the parts by flattening the elevation between punch tool and counter-tool by the punch tool further approaching the counter-tool. Furthermore, a device is suggested for carrying out said method.

### CROSS REFERENCE TO RELATED APPLICATIONS

The present application is a Continuation of pending prior international application Number PCT/EP2003/010843, filed on Sep. 30, 2003, which designated the United States. The present application claims priority to German Patent Application No. 102 45 604.6, filed Sep. 30, 2002, said German patent application being incorporated herein by reference.

### BACKGROUND OF THE INVENTION

1. Field of the Invention

The present invention relates to a method for permanently joining overlapping plate-shaped parts, particularly metal sheets, by producing an undercut between the parts in a deforming manner.

2. State of the Prior Art

Apart from this, the present invention relates to a device for permanently joining overlapping plate-shaped parts, particularly metal sheets, by producing an undercut between the parts in a deforming manner, the device comprising a punch tool that is movable along a main working direction towards and away from a counter-tool.

### SUMMARY OF THE INVENTION

In the sheet-metal working industry, individual parts are joined by manufacturing methods used in mechanical joining techniques. Inexpensive methods are above all used in the car industry in mass production, wherein at least two parts are connected to each other by plastic deformation of said parts without any kind of prefabricated hole and without the use of additional auxiliary joining parts.

Methods and devices for joining overlapping, particularly plate-shaped, parts have been known in the prior art for many years, wherein an undercut connection is established by local deformation of the parts to be joined. These methods are also designated as clinching in the literature.

In these methods, an overlapping area of the two or more parts to be joined is arranged between a punch tool and a counter-tool (die). This punch tool is then pressed directly into the joining portion of the (two) parts with great force, whereby both parts in the area of the punch attack are first deep-drawn into a recess formed in the die, and the bottom area of the deep-drawn portions is then squeezed in width.

The die is here formed such that when the bottom area of the deep-drawn portions is squeezed in width, undercuts may form between the parts. A distinction is here made among the employed methods in dependence upon the different types of the respective dies. Known is the use of rigid one-part dies, e.g. from DE 35 32 900 A1, DE 36 13 324 A1 or DE 199 29 375 A1. Apart from this, rigid multi-part dies are e.g. known from DE 39 23 18 A1, movable multi-part dies, e.g. from DE 31 06 313 A1, or DE 37 13 083 A1, and mixed forms, e.g. from DE 101 16 736 A1.

All of these different methods have in common the use of a contoured die as a counter-tool. The contour allows for a local deep-drawing of the parts to be joined or for a passage through the parts to be joined by way of a recess into which the material of the parts can be molded.

Furthermore, on account of its specific form or the movement of individual parts of the die, the contour allows for a material flow in radial direction, which results in the formation of the undercut.

However, in all of the methods of that type, an exact axial alignment of the tools relative to one another, particularly of die and punch, is imperative to produce high-quality joints. In practice, this requires a high manufacturing accuracy for the tools and machines and a lot of time for setting up such joining devices.

Moreover, the joining devices must be configured to be very stiff so that the great forces prevailing during the joining operation and the bending-up caused thereby on the joining devices do not create any quality-reducing offsets of the tools relative to one another.

It is therefore the object of the present invention to provide a method for mechanically joining at least partly superimposed, plate-shaped parts with the help of which reliable high-quality joints can be produced in parts at lower costs and more reliably than has so far been the case.

Furthermore, it is the object of the present invention to improve a device of the above-mentioned type such that the demands made on the manufacturing tolerances and the orientation of the tools of the device can be reduced to increase process security.

According to the invention this object is achieved in a method for permanently joining overlapping plate-shaped parts, particularly metal sheets, by producing an undercut between the parts in a deforming manner in a working stroke, the method comprising the individual steps: disposing the parts to be joined between a protrusion of a punch tool and a support area of a counter-tool, pressing the punch protrusion into the parts to be joined with formation of a temporary elevation on the side of the parts that faces the counter-tool, and separating areas thereof outside a sphere of influence of the punch protrusion from a support area of the counter-tool, and forming an undercut in the parts by further reducing a bottom thickness in the elevation.

Furthermore, the object is achieved for a device of the above-mentioned type according to the invention in that the counter-tool is configured to be substantially planar on its side facing the punch tool.

It is possible with the invention to produce permanent joints between at least partly superimposed plate-shaped parts, particularly metal sheets, through the cooperation of a punch tool and a counter-tool, the joint produced in this way having undercut portions that form a geometrical interlocking of the parts to be joined.

“Planar” in this context is to mean “even” or “plane” in the main.

Due to the planar counter-tool, which is preferably configured in the form of a flat anvil, the axial alignment of anvil and punch relative to one another is of minor importance—in contrast to the conventional clinching method. The necessary manufacturing accuracy for the tools and machines is reduced, just like the time needed for setting up the joining devices.

During the joining process offsets that are created by the great forces prevailing between anvil and punch have no or only little influence on the formation of the connection. The process reliability of the method increases because the counter-tool is not subject to great wear by virtue of its flat shape, and the quality increases independently of an exact alignment of the tools relative to one another.

The connection formed has a geometrical undercut portion, whereby a pretreatment is not required for the activation of the surface of the joining partners to be connected to one another.

Hence, in the present invention, an undercut connection can be established in a way similar to a clinch connection. In contrast to traditional clinch connections, the connection is however not established by way of a deep-drawing process with subsequent squeezing of the bottom area of the deep-drawn portions in width, which requires a die with a recess, but by a pressing operation by way of rearward flow, followed by widthwise squeezing of the material remaining underneath a punch face, the process being combinable with a simultaneous upsetting of the neck portion.

When the punch is pressed in, a material flow opposite to the punch movement is created when the hold-down force is limited, resulting in the formation of an elevation at the side of the counter-tool.

In the further process sequence, it is only this elevation that is in contact with the counter-tool. When the material pressed out of the plane of the lower sheet is squeezed in width in said elevation, the undercut is then formed by radial material flow. The recess of the counter-tool that is normally required for the clinching method is not needed for realizing this principle of the method.

Following the formation of the undercut, a further punch movement towards a flattening of the connection portion of the two workpieces may take place. Attention must here be paid to a corresponding power limitation for tool security.

A tumbling movement of the joining punch for realizing the formation of the undercut is not needed. However, it can be superposed for reducing the joining forces. Such a superposed movement may have the form of a circle or a rosette.

Furthermore, the active axial advance movement may also be superposed by an additional cyclic force. When the superposition of the tumbling movement with rosette form is applied together with the cyclic force superposition, both superpositions can be matched to one another such that the tumble direction of the punch and the cyclic additional punch force are definitely dependent on one another. A specific tumble direction of the punch, preferably upon increase in the tumble angle up to the maximum tumble angle α in tumble direction to the outside, has assigned thereto the maximum superposing force to achieve an optimum material flow.

According to a preferred embodiment the method of the invention includes a step for moving a hold-down means towards the counter-tool, whereby a defined holding force is exerted on the parts during plastic deformation. Furthermore, an additional step of stabilizing the parts by means of a counter-holder is possible, by which the parts are pressed in a direction opposite to the direction of movement of the punch tool to said tool.

It is thereby possible that the movement of the punch protrusion towards the counter-tool is superposed at least for part of the punch path with a tumble movement. The tumble movement may be in the form of a circle or rosette. It is also desirable that the punch, the hold-down means and/or the counter-holder are force-actuated hydraulically, pneumatically, magnetically, mechanically or piezoelectrically, the force actuation being preferably carried out by means of one or more pulses.

Likewise, it is possible that the force actuation takes place for at least part of the punch path by superposition of an additional cyclic force, and upon application of the tumble superposition with rosette form the tumble angle of the punch and the additional cyclic punch force are clearly matched to one another in dependence upon one another.

According to a preferred embodiment, the force actuation of the hold-down means is controlled and the movement of the punch increases considerably particularly at a defined point. The movement of the parts that is opposite to the direction of movement of the punch is thereby stopped and reversed.

It is possible in such a method that at a defined point of the movement of the punch the movement of the parts that is opposite to the direction of movement of the punch is stopped and reversed by a punch shoulder. It is also possible that at a defined point of the movement of the punch the movement of the parts that is opposite to the direction of the movement of the punch is stopped and reversed by a direct or indirect mechanical stop of the hold-down means on the punch. Preferably, following the formation of the undercut, a tool movement takes place for flattening the elevation.

In a device for permanently joining overlapping plate-shaped parts, particularly metal sheets, by producing an undercut between the parts in a deforming manner, particularly for carrying out the previously indicated method, said device comprises a punch tool which is movable along a main working direction towards and away from a counter-tool, wherein the counter tool at its side facing the punch tool, at least in the whole area of the punch tool, particularly of a punch face and a punch shoulder, preferably also of a hold-down means, is configured to be substantially planar. It is here desirable that a main body of the punch tool is provided at its side facing the counter-tool with a punch shoulder from which a punch protrusion projects.

Preferably, at least a main body of the punch tool is surrounded by a hold-down means which is movable relative to the main body. The main body is preferably biased relative to the hold-down means by way of a biasing element, particularly a hold-down spring, in a direction opposite to an advance direction of the punch tool.

According to a further preferred embodiment the main body of the punch tool is movable at least for part of its movement towards the counter-tool in a tumbling movement. In this process, a punch face, which is arranged on the punch shoulder, is configured to be substantially flat, particularly even, slightly spherical or slightly conical. The punch protrusion towards the punch face may here be configured to be slightly tapering.

It is possible that a punch face arranged on the punch shoulder is substantially at a right angle relative to a main working direction or is slightly inclined relative thereto. It is also possible that a transition from the punch face to a lateral surface of the punch protrusion is configured in the form of a radius or a drag curve. Likewise, it is possible that a transition from the punch face to a lateral surface of the punch protrusion is configured in the form of a bevel or a double bevel.

The shaped element forming the transition from the punch face to the lateral surface is here smaller than 0.2 millimeter. In all embodiments, the counter-tool is preferably configured as a one-part anvil, the side of the anvil that is oriented towards the punch tool being configured as a substantially flat, particularly even, slightly spherical or slightly conical support area for the parts.

According to a particularly preferred embodiment the support area of the counter-tool is larger than the elevation formed on the parts, preferably larger than the projection surface of the punch tool oriented towards said counter-tool, but particularly of the punch protrusion and the punch shoulder that can also be formed by the hold-down means. It is desirable that the dimensions of the support area of the counter-tool are larger than or substantially equal to the outer dimensions of the hold-down means.

Both a portion of the support area of the counter-tool that is opposite to the punch face and a portion of the support area of the counter-tool that is opposite to the punch shoulder are preferably substantially positioned in a plane perpendicular to the main working direction. The support area is configured at least in the area of the projection of the punch face and the punch shoulder, preferably also of the hold-down means, without any shoulders or recesses.

In these embodiments, it is possible that the anvil of the counter-tool is surrounded at least in part by a counter-holder, which is movable relative to the anvil in the main working direction. Said counter-holder can be actuated pneumatically, hydraulically, magnetically, mechanically and/or piezoelectrically with a force that is opposite to a punch and/or hold-down force.

According to an embodiment the main body of the punch tool, the hold-down means, the anvil and/or the counter-holder have circular or annular cross-sections. Alternatively, the main body of the punch tool, the hold-down means, the anvil and/or the counter-holder have a cross section differing from a circular shape, particularly a polygonal cross-section.

Further preferred embodiments of the method and of the apparatus are the subject matter of the respective subclaims.

### BRIEF DESCRIPTION OF THE DRAWINGS

The accompanying drawings, which are incorporated in and form a part of the specification, illustrate the preferred embodiments of the present invention, and together with the written description and claims, serve to explain the principles of the invention. In the drawings:

FIGS. 1a-c) show a first embodiment of the device of the invention in carrying out the method of the invention, wherein:

FIG. 1a shows an initial state,

FIG. 1b shows an intermediate state, and

FIG. 1c a final state after joining;

FIGS. 2a-c) show a second embodiment of the device of the invention with a hold-down means abutting on a stop, in carrying out the method of the invention, wherein

FIG. 2a shows an initial state,

FIG. 2b shows an intermediate state, and

FIG. 2c shows a final state after joining.

FIGS. 3a-d) show a third embodiment of the device of the invention with an anvil having a spring-loaded outer ring and a hold-down means abutting on a stop, in carrying out the method of the invention, wherein

FIG. 3a shows an initial state,

FIG. 3b a first intermediate state before the punch tool penetrates into the parts,

FIG. 3c a further intermediate state after a temporary elevation has been formed, and

FIG. 3d a final state after the parts have been joined.

FIG. 4 shows an alternative embodiment of the device of the invention with a punch tool having a tumbling punch, in carrying out the method of the invention, in an intermediate state.

### DETAILED DESCRIPTION OF THE PREFERRED EMBODIMENTS

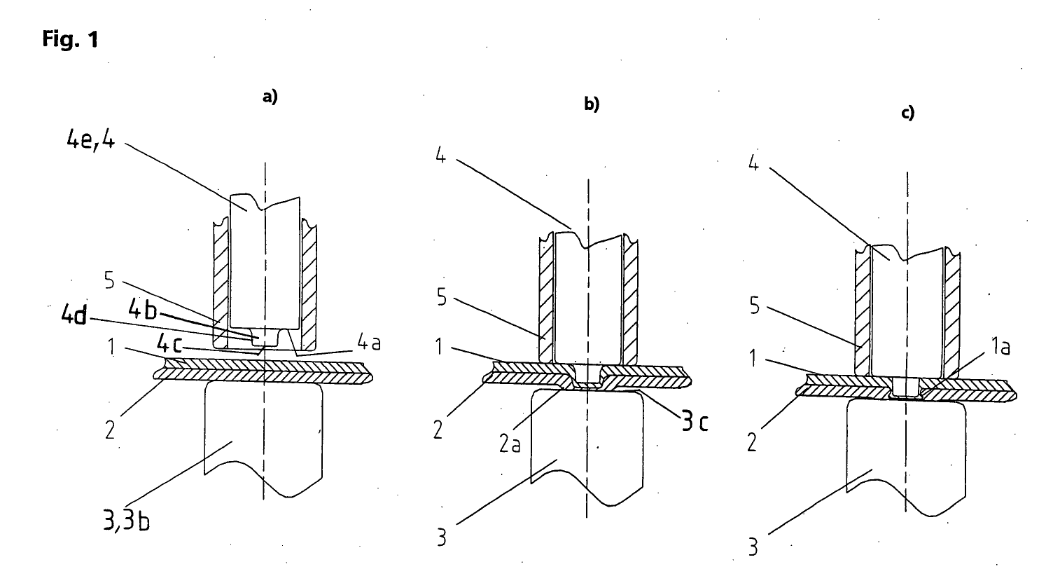

A first embodiment of the invention will now be explained in more detail with reference to FIGS. 1a) to 1c). In the description of the embodiments, the directions of movement and the relative arrangement of the components will be designated for the sake of clarity by the terms “top” and “bottom”, as illustrated in the figures. It goes without saying that any other spatial arrangement is possible in a corresponding way.

In the embodiment shown in FIG. 1, an upper part 1 is joined to a lower part 2. In the initial state, as shown in FIG. 1a, the two parts 1, 2 to be joined are disposed on a substantially flat support area 3c of the counter-tool 3, preferably a one-part anvil 3b.

For establishing the connection a punch tool 4 with a main body 4e and a hold-down means 5 is then moved towards the parts 1, 2 along a main working direction A onto the counter-tool 3. With the hold-down means 5, a defined holding force is exerted on the parts 1, 2 hydraulically, pneumatically, piezoelectrically, magnetically or by springs.

At the (lower) side of the main body 4e which is oriented towards the counter-tool 3, a punch protrusion 4b is formed with a cross section preferably smaller than the cross-section of the remaining (upper) part of the main body 4e. A punch shoulder 4a is formed on the transition, the shoulder being preferably flat and orthogonal in a plane or flat and slightly inclined (e.g. up to about 6°) relative to a main working direction A.

At the beginning of the clinching process proper, the punch protrusion 4b is then pressed hydraulically, pneumatically, magnetically, piezoelectrically or mechanically with great force into the parts 1, 2. The foremost (lowermost) section of the punch protrusion 4b, which is designated as a punch face 4c, is here advancing through the cross section of the upper part 1 into the part 2 without piercing one of the parts, so that the material of all parts to be joined still remains in front of the punch face during the whole process.

The respective material of the parts 1, 2, to be joined is displaced locally in this process and first moves radially outwards and then, controlled by the hold-down means 5 and/or the punch shoulder 4a, upwards against the direction of movement of the main body 4e of the punch.

Parts 1, 2 are here lifted from the support area 3c of the counter-tool 3 (anvil 3b). An elevation 2a is formed in the area of the punch protrusion 4b in that the sections of the parts 1, 2 that are not clamped between the punch face 4c and the support area 3c of the counter-tool 3 are moved by the pressed-away material of the parts upwards (towards the punch tool 4).

It is only in this area that a contact of the lower part 2 with the anvil 3b still exists on the bottom side of the lower part 2. FIG. 1b shows an intermediate state in which this can be seen clearly.

As soon as the material of the upper part 1 is in contact with the shoulder 4a of the main body 4e of the punch, the further movement of the material of the parts 1, 2 to be joined is impeded in a direction opposite to the direction of the punch movement. The resulting elevation 2a is therefore reduced in its size upon further advance of the punch tool 4, and the material, which is still below the face 4c of the punch 4, must flow radially outwards. As shown in FIG. 1c, an undercut 1a is formed in this process.

The ratio of the cross sections or diameters of punch protrusion 4b and punch shoulder 4a can be chosen in dependence upon the strength of the materials to be joined and of the joining force in such a way that no remaining impression of the punch shoulder 4a is created in the upper part 1.

The punch protrusion 4b can be made slightly conical to ensure an easy removal of the punch protrusion from the parts 1, 2 to be joined. The punch face 4c disposed on the punch protrusion 4b is preferably made flat, particularly planar, or also slightly spherical or slightly conical.

A transition from the punch face 4c to a lateral surface 4d of the punch protrusion 4b is here configured in the form of a radius or a drag curve; the transition from the punch face 4c to the lateral surface 4d of the punch protrusion 4b may, however, also be configured in the form of a bevel or a double bevel. At any rate, the shaped element forming the transition from the punch face 4c to the lateral surface 4d is preferably less than 0.2 millimeter.

As shown in the figures of the first embodiment, the counter-tool 3 is designed as a one-part anvil 3b whose side facing the punch tool 4 is configured as a substantially flat, particularly planar, but also as a slightly spherical or slightly conical support area 3c for the parts 1, 2.

In each embodiment, the support area 4c of the counter-tool 3 is larger than the diameter of an elevation 2a, so that the material of the parts 1, 2 cannot be pressed next to the support area laterally past said area. Preferably, the dimensions of the support area 3c of the counter-tool 3 are larger than or substantially equal to the outer dimensions of the hold-down means 5.

A portion of the support area 3c of the counter-tool 3 that is opposite to the punch face 3c, as well as a portion of the support area 3c of the counter-tool 3 that is opposite to the punch shoulder 4a, are substantially positioned in a plane perpendicular to the main working direction A, a slight curvature of the whole surface in upward or downward direction being however possible.

In each of the embodiments, the support area 3c is configured without any shoulders, recesses, depressions, hollows, or the like.

It is here possible that the main body 4e of the punch tool 4, the hold-down means 5 and/or the anvil 3b have circular or annular cross-sections, and it is also possible that the main body 4e of the punch tool 4, the hold-down means 5, and/or the anvil 3b have a cross-section differing from a circular form, particularly a polygonal cross-section. The individual components are preferably matched to one another, but are configured to be also movable independently of one another.

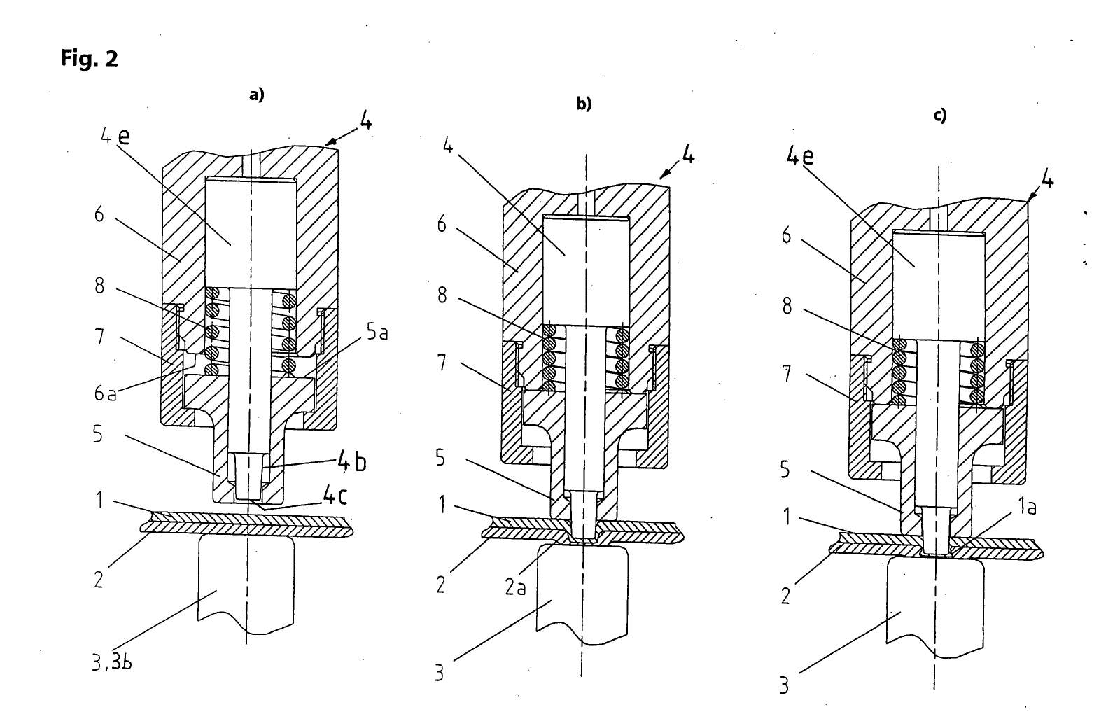

A second embodiment of the invention will now be described with reference to FIGS. 2a) to 2c). Parts and components corresponding to the previously described ones bear the same reference numerals and will only be described again if necessary.

A device for permanently joining two or more flat parts can be seen in a further embodiment in FIG. 2. In the initial state, as shown in FIG. 2a, the (two) parts 1, 2 to be joined rest again on the flat counter-cool 3, here the anvil 3b.

For producing the joint a punch tool 4 is moved hydraulically, pneumatically, magnetically, piezoelectrically or mechanically with great force towards parts 1, 2. In this embodiment, the punch tool 4 comprises a main body 4e of the punch, a hold-down means 5, a punch carrier 6, a hold-down sleeve 7, and a hold-down spring 8.

First of all the hold-down means 5 is placed on the parts 1, 2 to be joined. The hold-down spring 8 is compressed in this process. The face 4c of the punch protrusion 4b of the main body 4e of the punch then gets into contact with the upper part 1.

The punch protrusion 4b is now pressed fully or partly into parts 1, 2. The material of the parts 1, 2 to be joined is here displaced locally and first moves radially to the outside and then, controlled by the hold-down means 5, against the direction of movement of the punch tool 4 upwards. Parts 1,2 are lifted from the anvil 3b in this process. It is only in the area of the developing elevation 2a on the bottom side of the lower part 2 that there is still some contact of the lower part 2 with the anvil 3b. FIG. 2b shows an intermediate state in which this can be seen clearly.

As soon as an upper stop 5a of the hold-down means 5 gets into contact with a lower stop 6a of the punch carrier 6, the further movement of the material of the parts 1, 2 to be joined is impeded in a direction opposite to the one of the punch movement. The resulting elevation 2a is therefore reduced in its size during further advance of the punch tool, and the material that is still positioned under the face 4c of the punch protrusion 4b of the main body 4e of the punch must flow radially to the outside.

As shown in FIG. 2c, an undercut 1a is here formed. The ratio of the dimensions (or diameters) of the punch face 4c and the bottom side of the hold-down means 5 can be chosen in dependence upon the strength of the materials to be joined and of the joining power in such a way that no remaining impression of the hold-down means 5 is created in the upper part 1.

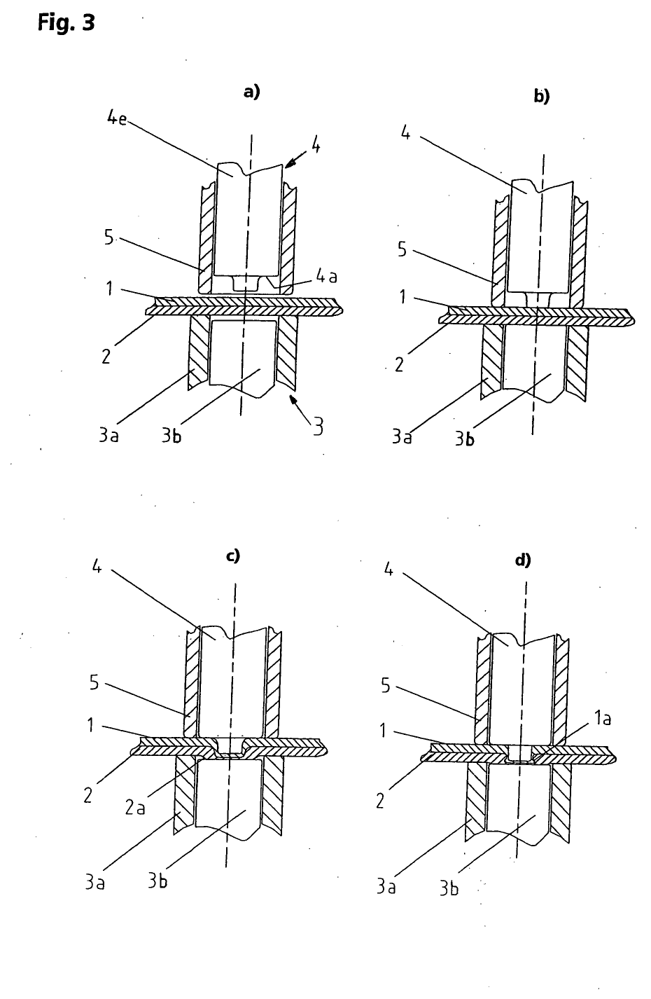

A third embodiment can be seen in FIGS. 3a) to 3d). Parts and components that correspond to the previously described ones bear the same reference numerals and will only be described again if necessary.

In an initial state, as shown in FIG. 3a, the (two) parts 1, 2 to be joined rest on a counter-holder 3a (outer ring) of an anvil 3b of the counter-tool 3 that is preferably spring-loaded or pressurized in another way.

For establishing the connection the hold-down means 5 and the main body 4e of the punch tool 4 are moved towards parts 1, 2. With the hold-down means 5, a defined force is exerted on the parts 1, 2 and on the counter-holder 3a hydraulically, pneumatically, piezoelectrically, magnetically, mechanically or in another way. The force with which the hold-down means 5 is acted upon is chosen to be preferably greater than the force of the counter-holder 3a acting in opposite direction.

As shown in FIG. 3b, the counter-holder 3a is thereby pressed back to such an extent that the parts 1, 2 to be joined come to rest on the anvil 3b. As has been described above, the punch protrusion 4b is then pressed with great force into the parts 1, 2. The material of the parts 1, 2 to be joined is displaced locally and will first move radially to the outside and then, controlled by hold-down means 5 and by counter-holder 3a, in a direction opposite to the direction of movement of the punch tool 4 upwardly. The parts 1, 2 are thereby lifted from the anvil 3b.

It is only in the area of the resulting elevation 2a on the bottom side of the lower part 2 that there is still some contact of the lower part 2 with the support area of the counter-tool 3, the anvil 3b.

In contrast to the previously described embodiments, the material moving in a direction opposite to the punch movement is no longer prevented from moving by the whole hold-down force, but only by the difference of the forces acting on the hold-down means 5 and the counter-holder 3a. As a result, high holding forces which prevent a deflection of the parts 1, 2 or a gap formation between the parts can be applied, with the parts 1, 2 being only prevented in a minimal way from lifting from anvil 3b.

It is here possible that the counter-holder 3a has a circular or annular cross-section and also that the counter-holder 4a has a cross section differing from a circular shape, particularly a polygonal cross-section. The individual components (main body 4e of the punch tool 4, hold-down means 5, anvil 3b and counter-holder 3a are preferably matched to one another, but are also configured to be movable independently of one another.

FIG. 3c shows a further intermediate state. As soon as the material of the upper part 1 is in contact with the shoulder 4a of the main body 4e of the punch, the further movement of the material of the parts to be joined is impeded in a direction opposite to the direction of the punch movement. The resulting elevation 2a is therefore reduced in its size upon further advance of the punch tool 4, and the material still positioned under the face 4c of the punch protrusion 4b must flow radially outwards. As shown in FIG. 3d, an undercut 1a is formed in this process.

Due to the great force with which the hold-down means 5 can be acted upon in this embodiment, the joined parts 1, 2 are stripped off without any problem from the punch protrusion 4b after the joining process when the tools 3, 4 are moved apart without the joining process being affected in any way.

The ratio of the cross-sections (diameters) of punch face 4c and punch shoulder 4a can be chosen again in dependence upon the strength of the materials to be joined and the joining force such that no remaining impression of the punch shoulder 4a is created in the upper part 1.

In this embodiment, too, no high accuracy is required with respect to the coaxial alignment of punch tool 4 relative to counter-tool 3 because the counter-holder 3 does not take part in the formation of the joint and only assumes a holding function. For achieving great forces at small distances, both the hold-down means 5 and the counter-holder 3a are already biased in the initial state.

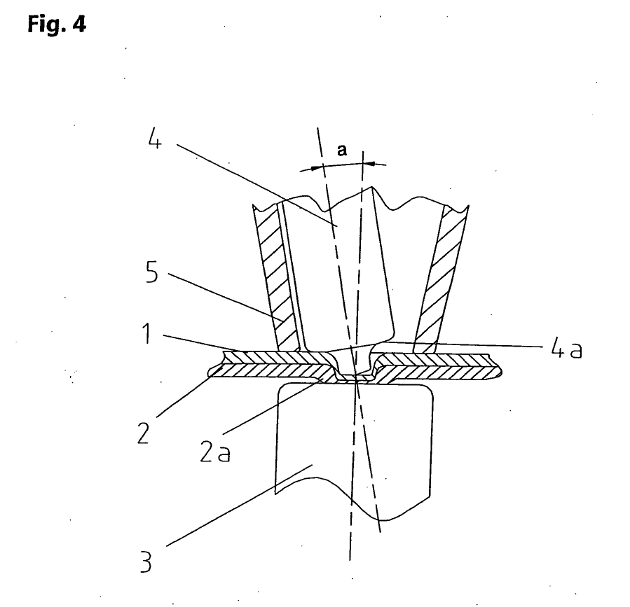

An alternative (fourth) embodiment, the teaching of which can be combined with any of the previously described embodiments (just like the first three embodiments with one another), is shown in FIG. 4.

As shown in this instance, a tumbling movement with a maximum tumble angle α between the main working direction A and an axis B of the main body 4e of the punch can be superposed on the main body 4e of the punch tool 4 for force reduction.

It is here important that, as described in the already explained embodiments, the force of the hold-down means 5 is dimensioned such that a deflection of the parts 1, 2 to be joined or a gap formation between the two parts 1, 2 is largely avoided, but the formation of the elevation 2a and thus a movement of the parts 1, 2 opposite to the axial movement of the main body 4e of the punch is made possible at the same time. A counter-holder 3a, as shown in the third embodiment, can here be provided.

As soon as the material of the upper part 1 gets into contact with the shoulder 4a of the main body 4e of the punch, the further movement of the material of the parts 1, 2 to be joined in a direction opposite to the direction of the punch movement is prevented. The resulting elevation 2a is therefore reduced in its size during further advance of the punch tool 4 and the material still positioned below the face 4c of the main body 4 of the punch, which face is preferably made conical, is bound to flow radially to the outside. As described in the other embodiments, an undercut is formed in this process.

The ratio of the diameter of punch face 4c and punch shoulder 4a can be chosen again in dependence upon the strength of the materials to be joined and the joining force in such a way that no remaining impression of the punch shoulder 4a is created in the upper part 1.

It goes without saying that with the method of the invention and with the device of the invention more than two parts can also be connected to one another. It is also clear that the counter-tool can also, or exclusively, be designed as a moved component. The arrangement of the tools in space is also left to one's discretion.

It is also possible to establish a plurality of connections at the same time. The geometrical contour of the tools and the joining places can be chosen substantially at will.

Any elastically deformable materials, particularly metal sheets and plastics, are suited as material for the parts to be joined. The individual parts may also consist of different materials.

The foregoing description is considered as illustrative of the principles of the invention. Furthermore, since numerous modifications and changes will readily occur to those skilled in the art, it is not desired to limit the invention to the exact construction and process shown and described above. Accordingly, resort may be made to all suitable modifications and equivalents that fall within the scope of the invention. The words “comprise,” “comprises,” “comprising,” “include,” “including,” and “includes” when used in this specification are intended to specify the presence of stated features, integers, components, or steps, but they do not preclude the presence or addition of one or more other features, integers, components, steps, or groups thereof.

The embodiments of the invention in which an exclusive property or privilege is claimed are defined as follows:

1. A method for permanently joining overlapping plate-shaped parts (1, 2), particularly metal sheets, by producing an undercut (1a) between the parts (1, 2) in a deforming manner in a working stroke, the method comprising the individual steps:
disposing the parts to be joined (1, 2) between a protrusion (4b) of a punch tool (4) and a support area (3c) of a counter-tool (3),
pressing the punch protrusion (4b) into the parts (1, 2) to be joined with formation of a temporary elevation (2a) on the side of the parts (1, 2) that faces the counter-tool (3), and separating areas thereof outside a sphere of influence of the punch protrusion (4b) from a support area (3c) of the counter-tool (3), and
forming an undercut (1a) in the parts (1, 2) by further reducing a bottom thickness in the elevation (2a).

2. The method according to claim 1, characterized by a step of moving a hold-down means (5) on the counter-tool (3) towards, and thus exerting a defined holding force on, the parts (1, 2) during plastic deformation.

3. The method according to at least one of claims 1 or 2, characterized by an additional step of stabilizing the parts (1, 2) by means of a counter-holder (3a) by which the parts (1, 2) are pressed in a direction opposite to the direction of movement of the punch tool (4) towards said tool.

4. The method according to at least one of claims 1 to 3, characterized in that the movement of the punch protrusion (4b) towards the counter-tool (3) is superposed with a tumble movement at least over part of the punch path, the tumble movement being preferably carried out in the form of a circle or rosette.

5. The method according to at least one of claims 1 to 4, characterized in that the punch (4), the hold-down means (5) and/or the counter-holder (3a) are force-actuated hydraulically, magnetically, mechanically or piezoelectrically, the force actuation being preferably carried out by means of one or several pulses.

6. The method according claim 5, characterized in that the force actuation for at least part of the punch path is carried out by superimposing an additional cyclic force, the tumble angle of the punch and the additional cyclic punch force being matched to one another clearly in dependence upon one another upon application of a tumble superposition in the form of a rosette.

7. The method according to at least one of claims 5 or 6, characterized in that the force actuation of the hold-down means (5) is carried out in a controlled way and strongly increases particularly at a defined point of the movement of the punch (4), and the movement of the parts (1, 2) that is directed opposite to the direction of movement of the punch (4) is thereby stopped and reversed, or that at a defined point of the movement of the punch (4) the movement of the parts (1,2) that is directed opposite to the direction of movement of the punch (4) is stopped and reversed by a punch shoulder (4a), or that at a defined point of the movement of the punch (4) the movement of the parts (1, 2) that is directed opposite to the direction of movement of the punch (4) is stopped and reversed by an indirect or direct mechanical stop (6a) of the hold-down means (5) on the punch.

8. The method according to at least one of claims 1 to 7, characterized in that following the formation of the undercut (1a) a tool movement is carried out for flattening the elevation (2a).

9. An apparatus for permanently joining overlapping plate-shaped parts (1, 2) particularly metal sheets, by producing an undercut (1a) between the parts (1, 2) in a deforming manner, particularly for carrying out a method according to claim 1, comprising:
a punch tool (4) which is movable along a main working direction (A) towards and away from a counter-tool (3),
characterized in that the counter-tool (3) is configured to be substantially planar on its side facing the punch tool (4).

10. The device according to claim 9, characterized in that a main body (4e) of the punch tool (4) is provided at its side facing the counter-tool (3) with a punch shoulder (4a) from which a punch protrusion (4b) projects.

11. The device according to any one of claims 9 or 10, characterized in that at least one main body (4e) of the punch tool (4) is surrounded by a hold-down means (5) which is movable relative to the main body (4e), the main body (4e) being preferably biased relative to the hold-down means (5) by means of a biasing element, particularly a hold-down spring (8), in a direction opposite to an advance direction of the punch tool (4).

12. The device according to at least one of claims 9 to 11, characterized in that the main body (4e) of the punch tool (4) is movable at least for part of its movement towards the counter-tool (3) in a tumbling movement.

13. The device according to at least one of claims 9 to 12, characterized in that a punch face (4c) which is arranged on the punch shoulder (4b) is configured to be substantially flat, particularly planar, slightly spherical or slightly conical, the punch protrusion (4b) being preferably configured to be slightly tapering towards the punch face (4c).

14. The device according to at least one of claims 9 to 13, characterized in that a punch face (4c) which is arranged on the punch shoulder (4b) is substantially at a right angle relative to a main working direction (A) or is slightly inclined relative to said direction.

15. The device according to at least one of claims 9 to 14, characterized in that a transition is formed from the punch face (4c) to a lateral surface (4d) of the punch protrusion (4b) in the form of a radius or a drag curve, or a transition is formed from the punch face (4c) to a lateral surface (4d) of the punch protrusion (4b) in the form of a bevel or a double bevel, the shaped element which forms the transition from the punch face (4c) to the lateral surface (4d) being preferably smaller than 0.2 millimeter at any rate.

16. The device according to at least one of claims 9 to 15, characterized in that the counter-tool (3) is designed as a one-part anvil (3b) whose side facing the punch tool (4) is configured as a substantially flat, particularly planar, slightly spherical or slightly conical support area (3c) for the parts (1, 2), the support area (3c) of the counter-tool (3) being preferably greater than the elevation (2a) formed on the parts (1, 2).

17. The apparatus according to claim 16, characterized in that the dimensions of the support area (3c) of the counter-tool (3) are larger than or substantially equal to the external dimensions of the hold-down means (5) and/or that the support area (3c) is configured without shoulders or recesses.

18. The device according to at least one of claims 16 or 17, characterized in that both a portion of the support area (3c) of the counter-tool (3) that is opposite to the punch face (4c) and a portion of the support area (3c) of the counter-tool (3) that is opposite to the punch shoulder (4a) are substantially in a plane perpendicular to the main working direction (A).

19. The device according to at least one of claims 16 to 18, characterized in that the anvil (3b) of the counter-tool (3) is surrounded at least in part by a counter-holder (3a) which is movable relative to the anvil (3b) in the main working direction (A), the counter-holder (3a) being preferably actuable pneumatically, hydraulically, magnetically, mechanically and/or piezoelectrically by a force that is opposite to a force of the punch and/or hold-down means.

20. The device according to at least one of claims 9 to 19, characterized in that the main body (4e) of the punch tool (4), the hold-down means (5), the anvil (3b) and/or the counter-holder (3a) have circular or annular cross-sections, or that the main body (4e) of the punch tool (4), the hold-down means (5), the anvil (3b) and/or the counter-holder (3a) have a cross-section differing from a circular shape, particularly a polygonal cross-section.
